(19) United States
(12) Patent Application Publication
(10) Pub. No.: US 2007/0271844 A1
(43) Pub. Date: Nov. 29, 2007

(54) Hydrogen fuel cartridge and methods for hydrogen generation

(76) Inventors: Richard M. Mohring, East Brunswick, NJ (US); Keith A. Fennimore, Columbus, NJ (US)

Correspondence Address: DICKSTEIN SHAPIRO LLP, 1825 EYE STREET NW, Washington, DC, 20006-5403, US

(21) Appl. No.: 11/783,857

(22) Filed: Apr. 12, 2007

Related U.S. Application Data
(60) Provisional application No. 60/791,215, filed on Apr. 12, 2006.

(51) Int. Cl. B01J 7/00; B01J 8/00; H01M 8/04

(52) U.S. Cl. 48/61; 429/12; 429/34; 48/199 FM

(57) ABSTRACT

Systems and methods are provided for generating hydrogen gas using a catalyst or reagent and a boron hydride compound. The preferred hydrogen generation system includes a fuel cartridge and a hydrogen generation system balance of plant (BOP) module. Solid fuel is stored in individual fuel packets in a fuel chamber, and converted into a fuel solution. Fuel is pumped to a reactor where it produces hydrogen and borate. The hydrogen and borate product exit the reactor and are deposited in a hydrogen separation chamber separated from the fuel chamber by a moveable partition. Hydrogen is separated by a membrane and exits the generator. As fuel is consumed, the movable partition is disposed toward the fuel chamber and the borate product is deposited on one side of the movable partition. The controls are preferably contained in the BOP module.

### FIELD OF THE INVENTION

The invention relates to a system for generating hydrogen gas using fuel solutions of borohydride compounds. More particularly, the invention relates to a system for hydrogen generation that produces a fuel solution as needed from dry fuel components. This invention claims priority to U.S. Provisional Application Ser. No. 60/791,215, filed Apr. 12, 2006, which is hereby incorporated herein in its entirety.

### BACKGROUND OF THE INVENTION

Although hydrogen is the fuel of choice for fuel cells, its widespread use is complicated by the difficulties in storing the gas. Many hydrogen carriers, including hydrocarbons, metal hydrides, and chemical hydrides, are being considered as hydrogen storage and supply systems. In each case, specific systems need to be developed to release the hydrogen from its carrier, either by reformation as in the case of hydrocarbons, desorption from metal hydrides, or catalyzed hydrolysis from chemical hydrides and water.

One of the more promising systems for hydrogen storage and generation utilizes borohydride compounds as the hydrogen storage media. Sodium borohydride (NaBH₄) is of particular interest because it can be dissolved in alkaline water solutions with virtually no reaction; in this case, the stabilized alkaline solution of sodium borohydride is referred to as fuel. Furthermore, the aqueous borohydride fuel solutions are non-volatile and will not burn. This imparts handling and transport ease both in the bulk sense and within the hydrogen generator itself.

Various hydrogen generation systems have been developed for the production of hydrogen gas from aqueous sodium borohydride fuel solutions. Such generators typically require at least three chambers, one each to store fuel and borate product, and a third chamber containing a catalyst or other reagent to promote hydrolysis of the borohydride. Hydrogen generation systems can also incorporate additional components such as hydrogen ballast tanks, heat exchangers, condensers, gas-liquid separators, filters, and pumps.

The development of fuel cells as replacements for batteries is dependent on finding a convenient and safe hydrogen source. A fuel cell power system for small applications needs to be compact and lightweight, have a high gravimetric hydrogen storage density, and preferably be operable in any orientation. Additionally, it should be easy to match the control of the system's hydrogen flow rate and pressure to the operating demands of the fuel cell.

The present invention provides, in one embodiment, a fuel cartridge for a hydrogen generation system that stores a solid fuel and incorporates a volume-exchange configuration for the storage of the fuel solution and the product.

### BRIEF SUMMARY OF THE INVENTION

The invention relates to a system for generating hydrogen gas using a catalyst or reagent and a boron hydride compound.

The invention also relates to a system for generating hydrogen gas from a borohydride compound using a catalyst. In one aspect of the present invention, a hydrogen generation system is provided that includes fuel cartridges and a hydrogen generation system balance of plant (BOP) module. Solid fuel is preferably stored in individual fuel packets in a fuel chamber, and converted into a fuel solution. Fuel is pumped to a reactor where it produces hydrogen and borate. The hydrogen and borate product exit the reactor and are deposited in a hydrogen separation chamber separated from the fuel chamber by a moveable partition. Hydrogen is separated by a membrane and exits the generator. Preferably, as fuel is consumed, the moveable barrier is disposed toward the fuel chamber and the borate product is deposited on one side the moveable barrier. All controls are preferably contained in the BOP.

### BRIEF DESCRIPTION OF THE DRAWINGS

A complete understanding of the present invention may be obtained by reference to the accompanying drawings when considered in conjunction with the following detailed description, in which:

FIG. 1 is a fuel cartridge with individual fuel packets in accordance with an embodiment of the present invention.

FIG. 2 is a fuel cartridge with individual fuel packets and containing a fuel solution in accordance with an embodiment of the present invention.

FIG. 3 is a schematic illustration of the balance of plant module interface in accordance with another embodiment of the present invention.

FIG. 4 is a schematic illustration of an overall power system according to the invention comprising fuel cartridge, BOP, water management, control, and power modules.

FIG. 5 is a schematic as in FIG. 4 including multiple BOP, fuel cartridge, and power modules.

### DETAILED DESCRIPTION OF THE INVENTION

A process for generating hydrogen from a stabilized metal hydride solution is described in U.S. Pat. No. 6,534,033, entitled “A System for Hydrogen Generation,” the content of which is hereby incorporated herein by reference in its entirety. In the '033 patent, hydrogen is produced from solutions of borohydride compounds, as shown in Equation (1), where MBH₄ and MBO₂, respectively, represent an alkali metal borohydride and an alkali metal metaborate. A simplified stoichiometry is provided in Equation (1); wherein n is variable and determined by the temperature and nature of the borohydride, among other factors. For sodium borohydride (NaBH₄), n preferably is 2.
MBH₄+(2+n)H₂O→MBO₂.nH₂O+4H₂+heat Equation (1)

The present invention provides a fuel cartridge system that delivers a solid fuel component in conveniently pre-packed dosages, to facilitate dispensing, storage and handling of such solid fuel component, while providing a protective barrier against water and other contaminants. The fuel cartridge system easily delivers pre-measured quantities of the solid fuel for hydrogen generation in conveniently packaged units. The solid fuel is a boron hydride compound that is stored in a dry form and mixed with a liquid, as needed. The liquid may include water. The solid fuel component may be provided in various forms, including but not limited to, granules, pellets and powder, for example.

Boron hydrides as used herein include boranes, polyhedral boranes, and anions of borohydrides or polyhedral boranes. Suitable boron hydrides include, without intended limitation, neutral borane compounds such as decaborane(14) (B₁₀H₁₄); ammonia borane compounds of formula NHₓBH_{y} and NHₓRBH_{y}, wherein x and y independently equal 1 to 4 and do not have to be the same, and R is a methyl or ethyl group; borazane (NH₃BH₃); borohydride salts (M(BH₄)ₙ), triborohydride salts (M(B₃H₈)ₙ), decahydrodecaborate salts (M₂(B₁₀H₁₀)ₙ), tridecahydrodecaborate salts (M(B₁₀H₁₃)ₙ), dodecahydrododecaborate salts (M₂(B₁₂H₁₂)ₙ), and octadecahydroicosaborate salts (M₂(B₂₀H₁₈)ₙ), where M is a cation selected from the group consisting of alkali metal cations, alkaline earth metal cations, aluminum cation, zinc cation, and ammonium cation, and n is equal to the charge of the cation. M is preferably sodium, potassium, lithium, or calcium. The boron hydride fuels may contain a stabilizer component, such as a metal hydroxide having the general formula M(OH)ₙ, wherein M is a cation selected from the group consisting of alkali metal cations such as sodium, potassium or lithium, alkaline earth metal cations such as calcium, aluminum cation, and ammonium cation, and n is equal to the charge of the cation.

The advantage of fuel cell power systems over batteries is that they are readily refuelable, and therefore can contain a “replaceable” fuel cartridge module, and a “permanent” power module. The fuel cartridge module may be disposable, or may simply be refillable, and comprises fuel storage and hydrogen generation components. The power module comprises the fuel cell module, and more specifically the fuel cell stack and related balance of plant components. The hydrogen generation system's balance of plant with means for fuel regulation and other controls may be incorporated in the power module or may be a separate component. The elements in the power module may be intended to last the lifetime of the power production device.

In fuel cartridge modules based on a boron hydride hydrogen generation system, the fuel solutions may be conveyed from a fuel storage area through a reactor chamber to undergo the reaction depicted in Equation (1), the resultant borate byproduct and hydrogen gas separated in a hydrogen separation region, and the hydrogen gas fed to the fuel cell unit. The hydrogen generation process and liquid fuel flow to the reactor are preferably regulated (by a hydrogen generation balance of plant, for example) in accordance with the hydrogen demands of the fuel cell.

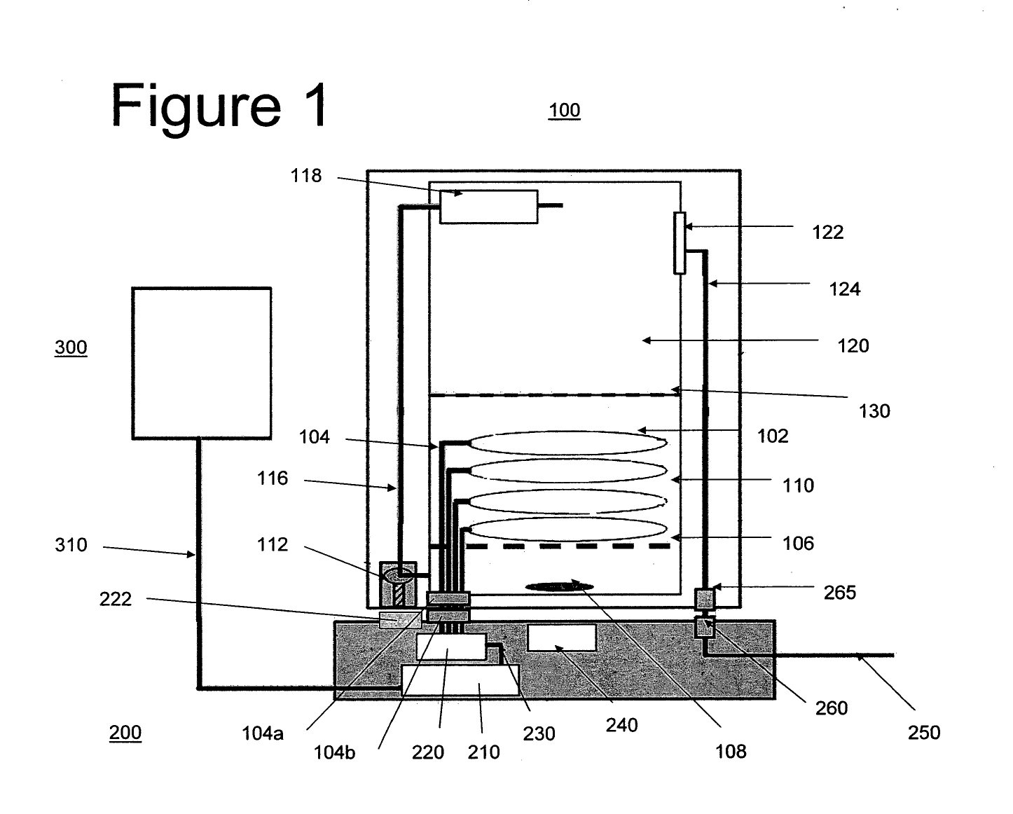

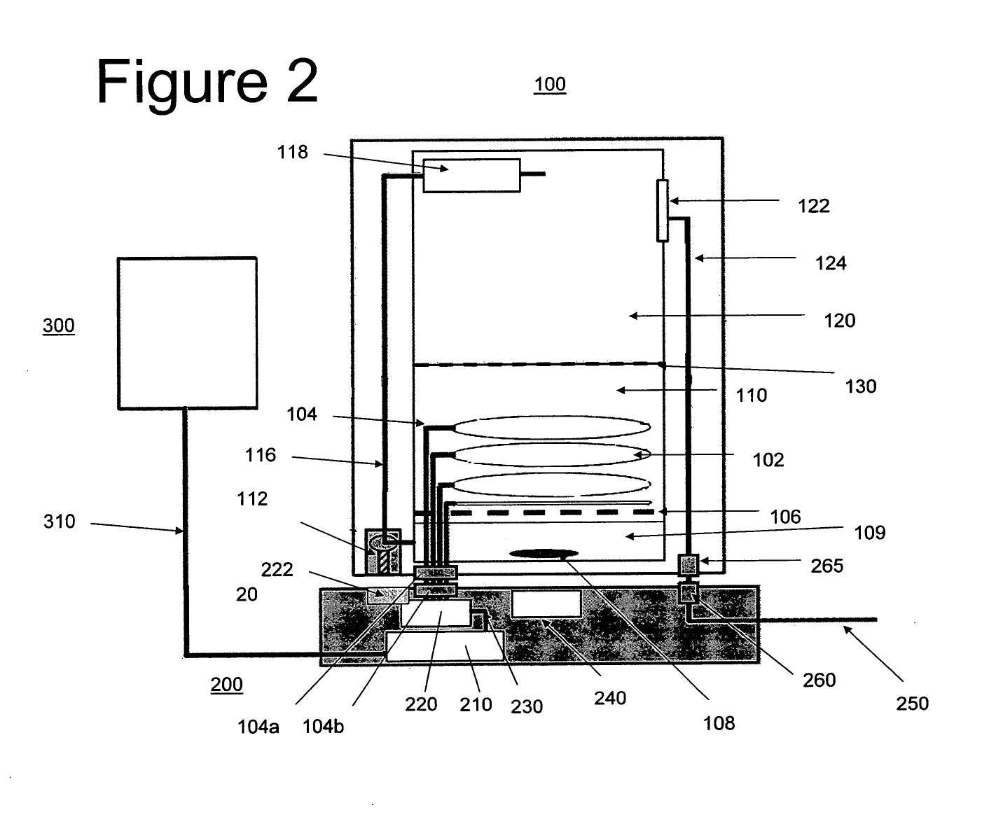

Referring to FIGS. 1 and 2, where like elements are designated by like reference numerals, an exemplary fuel system comprises a fuel cartridge 100, a balance of plant module 200, and a water management module 300 in accordance with the present invention.

Preferably, the fuel cartridge 100 comprises a fuel storage chamber 110 and a hydrogen separation chamber 120 separated by a movable partition 130 such that the fuel and the products can occupy the same volume in a volume-exchanging configuration. That is, the fuel storage chamber 110 is initially “full” and the hydrogen separation chamber 120 is initially “empty”. The term “movable partition” as used herein includes moveable walls and pistons as well as flexible walls; it is not necessary for the partition as a whole be moveable, only that at least some portion of the partition be moveable. In some embodiments, the hydrogen separation 120 is a flexible chamber such as a bladder or bag, and at least one wall of the flexible chamber functions as moveable partition; a separate moveable partition element need not be present in such configurations. Examples of such flexible hydrogen separation chambers are disclosed for example, in co-pending U.S. patent application Ser. No. 11/340,484 entitled “Hydrogen Generation System and Method” and U.S. Pat. No. 7,105,033 B2 entitled “Hydrogen Gas Generation System,” the contents of which are hereby incorporated herein by reference in their entirety.

The fuel storage chamber 110 can further include an optional mixing element 108 and a screen 106. Generally, any method of mixing can be used and mixing element 108 may comprise a mechanical mixing device such as a tumbler, propeller, magnetic stirrers or blender, or a physical mixing device such as a vibration mixer, sonicator, circulation pump or air nozzle; preferably mixing element 108 is a magnetic stirrer comprised of a magnetic stir bar in the fuel chamber 110 and a rotating magnet within fuel mixer driver 240 in the balance of plant module 200. Illustratively, the mixing mechanism can start before, at the same time, or after the solid and liquid fuel components are dispensed. The mixing mechanism may run continuously or intermittently.

The solid fuel is contained within the fuel chamber 110 in one or more individual packets 102, each connected to an input tube 104 that is in communication with the balance of plant module 200. Each input tube 104 may comprise a separable interface between the fuel cartridge and the balance of plant with an inlet 104a at the fuel cartridge and outlet 104b at the BOP module. The number and size of the individual packets 102 can be varied according to, for example, the size of the hydrogen generating system, the desired runtime, and desired power output. As an exemplary system to further explain in more detail a preferred embodiment of the invention, a hydrogen generation system constructed to provide hydrogen to provide about twelve hours of runtime at 500 W of power when connected to a fuel cell power system, the equivalent of 6000 Wh, would use four packets each containing 450 g of solid sodium borohydride fuel blend in each packet. Each would require the addition of approximately 1800 g of water to make an aqueous fuel with a concentration of about 20 wt % NaBH4. Alternatively, two packets each containing 900 g of solid sodium borohydride fuel blend could be used.

In one exemplary embodiment, the fuel packets 102 are composed of a flexible liquid-tight material, such as, but not limited to: nylon; polyurethane; polyvinylchloride (PVC); polyethylene polymers including low density polyethylene (LDPE), linear low density polyethylene (LLDPE), high density polyethylene (HDPE), and ethylene-vinyl acetate copolymers (EVA); natural rubber; synthetic rubber; or metal foil.

In another exemplary embodiment, the packets 102 may be dissolvable packets of, for example: cellulose, starch, polyvinyl alcohol (PVA), polyurethane, or other dissolvable material.

Water is delivered to the fuel packets 102 from the water management module 300 using a pump 210, a regulator 220, and a water conduit 230 in the balance of plant module 200. The regulator 220 may comprise a multiplexing valve with multiple ports configured to direct water from the water management module 300 to each fuel packet 102 in succession. That is, water is directed into a single fuel packet 102 at a time.

Each packet 102 can preferably expand to a capacity sufficient to hold the appropriate amount of water and fuel (thus, in the nonlimiting exemplary case, 1800 g of borohydride fuel and 450 g of water) before rupturing to allow the liquid to escape. Alternatively, the packet 102 may be undersized to rupture prior to receiving the full measured amount of water. Once the fuel packet 102 has filled completely, the system will detect the rupture of the packet, for instance but not limited to, by measuring an increase in the discharge pressure of the water pump 210 just prior to the packet 102 rupturing. As the packet 102 breaks, the discharge pressure will drop and the water pump will stop flowing water into the system. Alternatively, the amount of water input into a given fuel packet 102 could be measured or predetermined, and another means of rupturing the packet 102 (such as a mechanical puncturing) could be employed. Referring to FIG. 2, the fuel cartridge 100 is shown with a liquid fuel solution 109. The level of the liquid fuel solution 109 may fall below the fuel packets 102, or may submerge one or more of the fuel packets.

The solid fuel does not need to completely dissolve in the water within the fuel packet, particularly if an optional mixing element 108 is included within the fuel cartridge. The mixing element 108 will engage to ensure that the solids are substantially dissolved into the water to form a fuel solution 109. The perforated screen 106 prevents the fuel packets 102 from physically interfering with the mixing element 108.

The cartridge 100 further comprises a fuel regulator 112, a fuel conduit 116, a reaction chamber 118, a hydrogen separator 122, and a hydrogen outlet 124. The cartridge 100 optionally further comprises a memory chip for storing information relevant to the cartridge such as, for example, cartridge identification, amount of fuel remaining, elapsed runtime, and system errors.

In the operation of the hydrogen gas generating system, fuel regulator 112 feeds the fuel solution 109 from the fuel chamber 110 to the reaction chamber 118 to undergo the reaction depicted in Equation (1). The moveable partition 130 is movable to allow the solid and liquid products to occupy the volume initially occupied by the fuel.

The reaction chamber 108 used with this embodiment preferably contains a reagent, such as a catalyst metal supported on a substrate. Suitable transition metal catalysts for the generation of hydrogen from a metal hydride solution include metals from Group 1B to Group VIIIB of the Periodic Table, either utilized individually or in mixtures, or as compounds of these metals. Representative examples of these metals include, without intended limitation: transition metals represented by the copper group, zinc group, scandium group, titanium group, vanadium group, chromium group, manganese group, iron group, cobalt group and nickel group. Specific examples of useful catalyst metals include, without intended limitation: ruthenium, iron, cobalt, nickel, copper, manganese, rhodium, rhenium, platinum, palladium, and chromium. The preparation of such supported catalysts is taught, for example, in U.S. Pat. No. 6,534,033 entitled “System for Hydrogen Generation,” the disclosure of which is incorporated herein by reference. Other suitable catalysts or reagents that promote the reaction of boron hydride compounds such as unsupported metals, acids, or heat can alternatively be present in the reaction chamber 118. These catalysts and reagents can be combined to work in concert for the production of hydrogen; for example, heat may be used with a supported metal catalyst system.

The products leave the reaction chamber 118 and enter hydrogen separation chamber 120 where the borate is retained while the hydrogen gas passes through an optional hydrogen separator 122 in communication with hydrogen outlet line 124, and which preferably precedes or is incorporated in the inlet to the hydrogen outlet line 124.

The hydrogen occupies any void space in the fuel cartridge 100 until it is removed from the cartridge 100. The separator 122 may be a hydrogen permeable membrane or filter. Suitable gas permeable membranes include materials that are more permeable to hydrogen than a liquid such as water, such as silicon rubber, polyethylene, polypropylene, polyurethane, fluoropolymers or any hydrogen-permeable metal membranes, such as palladium-gold alloys. Suitable gas permeable membranes include materials that are microporous and hydrophobic and/or oleophobic.

The hydrogen produced by the fuel cartridge 100 is delivered through hydrogen conduit 124. The hydrogen can be delivered to a power module comprising a fuel cell or hydrogen-burning engine for conversion to energy, or a hydrogen storage device, such as hydrogen cylinders, metal hydrides, or balloons. Optionally, conduit 124 connects to the balance of plant module 200 and hydrogen can be delivered from the balance of plant module 200.

Preferably fuel regulator 122 is the pump head of a peristaltic pump, a piston pump, a diaphragm pump, or other such pump having a pump head that is driven by a motor wherein the pumping mechanism can be external to fuel line 116. In general, peristaltic and piston pumps operate through the use of a pump head comprised of a series of fingers in a linear or circular configuration or at least one piston which can compress the fuel line 116; the fingers may be in a variety of configurations and alternatively referred to as rollers, shoes, or wipers. The compression of the fuel line 116 by the fingers forces the liquid through the line; when the line is not compressed and open, fluid flows into the fuel line. A diaphragm pump configuration comprises a diaphragm in the wall of fuel line 116, check valves on the upstream and downstream sides of the diaphragm, and a pump head. In general, diaphragm pumps operate through the use of a pump head comprised of a series of cams in a linear or circular configuration or at least one piston which can compress the diaphragm; the compression of the membrane by the fingers forces the liquid through the line; when the membrane expands and is not compressed, fluid is drawn into the fuel line. The cams may be in a variety of configurations and alternatively referred to as rollers, shoes, or wipers. The check valves constrain and control the directional flow through the diaphragm and fuel line 116.

In another embodiment of a diaphragm pump configuration, fuel regulator 112 is a diaphragm that further comprises a piezoelectric crystal that is in electrical communication with fuel pump driver 222 which comprises an electrical contact. Upon the application of an oscillating voltage to the piezoelectric crystal, a diaphragm pumps fluid through the conduit line as described previously for the mechanically controlled diaphragm. Alternatively, fuel regulator 112 can comprise a pump and motor driven by an electrical power supplied via fuel pump driver 222.

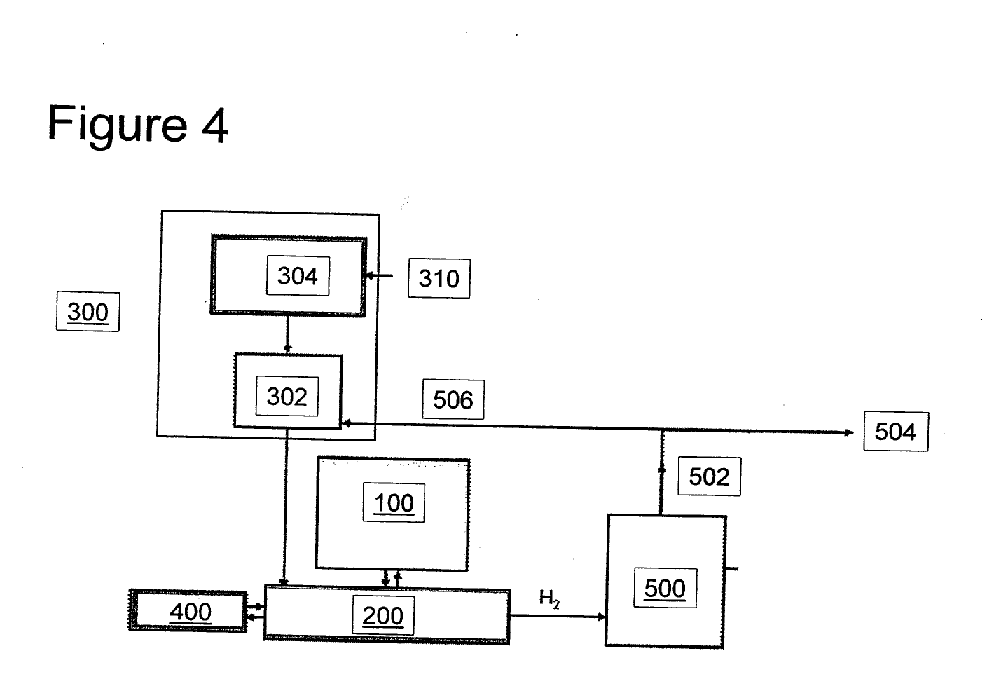

The fuel pump driver 222 preferably resides in the balance of plant module 200 and provides either mechanical or electrical energy to the fuel regulator and may comprise a motor or an electrical contact as described above. The fuel pump driver 222 varies the pumping speed of the fuel regulator 112 in response to control signals from the control unit that may be contained within the balance of plant module 200 or in the power module. For example, when the electrical power demand from the fuel cell 500 (FIG. 4) decreases, the control unit can signal the fuel pump driver 222 to operate its motor at lower speed, thus reducing the fuel flow to reaction chamber 118, which in turn reduces the rate of hydrogen production. If the electrical demand from fuel cell 500 is zero, the fuel pump driver 222 will operate such that no fuel will be propelled through fuel line 116. Likewise, when the electrical power demand increases, fuel pump driver 222 operates to increase fuel flow to reaction chamber 118, and increasing the rate of hydrogen production.

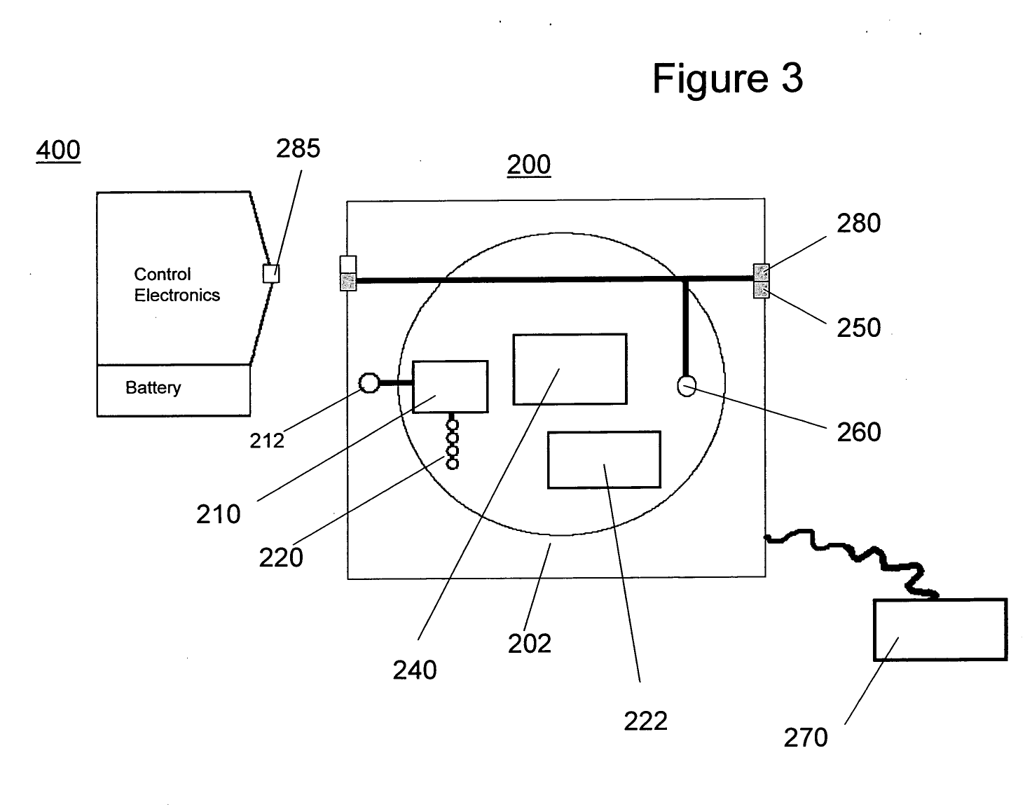

Referring now to FIG. 3, wherein features that are the same as those shown in previous figures are designated by like reference numerals, the balance of plant module 200 comprises a fuel pump driver 222, fuel mixer driver 240, at least one optional hydrogen inlet 260 connecting the BOP module 200 with the hydrogen conduit from the fuel cartridge 100 via a hydrogen outlet 265, and at least one hydrogen outlet 250 configured to deliver hydrogen. The fuel cartridge module 100 may be connected to the balance of plant module 200 in any suitable way. FIG. 3 also shows electronic interfaces 285 and 280, water inlet 212 for communication with conduit 310, and cartridge seat 202.

Preferably, the BOP module 200 further includes at least one heat exchanger 270 in communication with the fuel cartridge 100. The at least one optional heat exchanger 270 can operate to remove heat from at least one of the reaction chamber 118, the cartridge body as a whole, or the hydrogen stream. In some configurations, the at least one heat exchanger 270 is removably attached to the top of the fuel cartridge 100 and connected by a cable or tether to the BOP module 200. The at least one heat exchanger 270 can comprise either liquid- or air-cooling loops, fans, radiators and/or heat fins.

Control electronics for the hydrogen generation modules may be incorporated into the BOP module 200 or may comprise a separate control module 400, as illustrated in FIG. 3. Preferably the control module 400 comprises a battery to handle load prior to operation of the hydrogen generator and associated fuel cell power system during startup. Alternatively, the control module 400 can be in electrical communication with a separate battery. The battery may be recharged by the system during operation. A hybridization battery will also provide for higher peak load capacity as well as allowing the cartridges to be changed during operation without shutting down the system (referred to as “hot-swappable” cartridges).

Preferably, the control module 400 includes microcontrollers to handle a mix of analog and digital I/O and controls start up, running, and shut down of the system. Components may monitor operating parameters such as, but not limited to, liquid levels, runtime operational errors, and state of charge and energy management of the battery.

Referring to FIG. 4, wherein features that are the same as those shown in previous figures are designated by like reference numerals, an exemplary power system comprises a fuel cartridge module 100, a balance of plant module 200, a water management module 300, a control module 400, and a fuel cell power module 500. Optional water conduits 502, 504 and 506 may be provided to manage water produced in the power module and convey it to the water management module 300.

Water management module 300 comprises a water reservoir 302 and a water filtration system 304 that allows for impure water to be used for hydrogen generation. Various impure waters such as urine, brackish water, sea water, lake water, hard and soft waters, and gray water (wastewater produced by dishwashing, clothes washing and bathing) can be processed by the water filtration system 304 via input 310. Fresh water may be added directly to the water reservoir 302, as can water produced by the fuel cell, via input 506. Water produced by the fuel cell can alternatively be withdrawn for other uses, such as drinking, via water conduit 504.

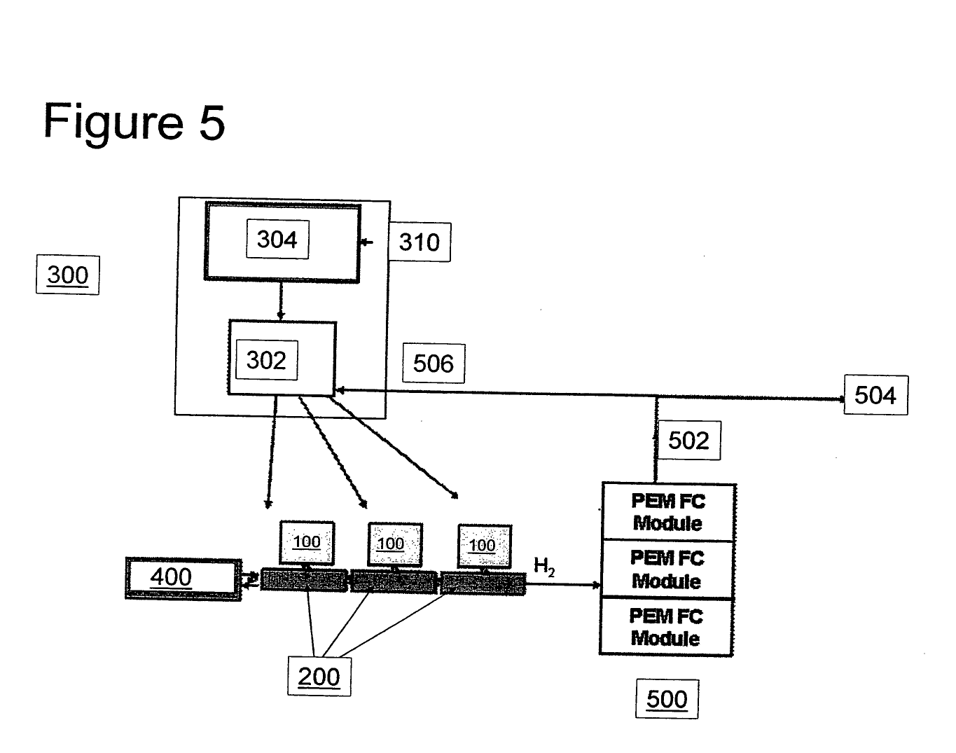

Multiple balance of plant modules 200 and fuel cartridges 100 can be connected to provide sufficient hydrogen fuel for fuel cell power systems as illustrated in FIG. 5, wherein features that are the same as those shown in previous figures are designated by like reference numerals. The number of fuel cartridge 100 and balance of plant modules 200 can be varied to fulfill the runtime and/or power demands of the intended use. Preferably, the controller unit can automatically detect the number and identification of the BOP modules 200 and relay status information such as the state of charge of each cartridge 100, and manage either parallel or serial operation of the balance of plant 200 and fuel cartridge units 100. Preferably, each balance of plant module 200 comprises at least one valve, such as a solenoid or check valve, to allow an individual BOP module 200 to be isolated from others in a system.

While the present invention has been described with respect to particular disclosed embodiments, it should be understood that numerous other embodiments are within the scope of the present invention. For example, while the figures illustrate one particular horizontal orientation of the fuel packets and hydrogen separation chamber, additional embodiments wherein the fuel packets and hydrogen separation chamber are oriented vertically or in other spatial arrangements are within the scope of the present invention.

What is claimed as new and desired to be protected by Letters Patent of the United States is:

1. A hydrogen generation system comprising:
a fuel cartridge;
a balance of plant module in fluid communication with the fuel cartridge; and
a hydrogen outlet in fluid communication with the fuel cartridge;
wherein the fuel cartridge comprises:
a hydrogen separation chamber;
a fuel storage chamber, including at least one individual fuel packet containing a solid fuel; and
a fuel regulator; and
wherein the balance of plant module comprises a fuel pump driver.

2. The hydrogen generation system of claim 1, wherein the hydrogen separation chamber and the fuel storage chamber are separated by a moveable partition such that the hydrogen separation chamber and the fuel storage chamber are configured in a volume-exchange configuration.

3. The hydrogen generation system of claim 1, wherein the fuel storage chamber contains a plurality of individual fuel packets.

4. The hydrogen generation system of claim 1, wherein each of the at least one individual fuel packet is connected to an input tube which is in communication with the balance of plant module.

5. The hydrogen generation system of claim 1, wherein each of the at least one individual fuel packet comprises a flexible liquid-tight material.

6. The hydrogen generation system of claim 5, wherein the flexible liquid-tight material is selected from the group consisting of nylon, polyurethane, polyvinylchloride (PVC), low density polyethylene (LDPE), linear low density polyethylene (LLDPE), high density polyethylene (HDPE), and ethylene-vinyl acetate copolymers (EVA), natural rubber, synthetic rubber, and metal foil.

7. The hydrogen generation system of claim 1, wherein each of the at least one individual fuel packet comprises a dissolvable material.

8. The hydrogen generation system of claim 7, wherein the dissolvable material is selected from the group consisting of cellulose, starch, polyvinyl alcohol (PVA) and polyurethane.

9. The hydrogen generation system of claim 1, wherein each of the at least one individual fuel packet is capable of expanding to a capacity sufficient to hold a predetermined amount of water.

10. The hydrogen generation system of claim 9, wherein each of the at least one individual fuel packet is further configured to rupture.

11. The hydrogen generation system of claim 1, further comprising a reaction chamber in communication with the hydrogen separation chamber of the fuel cartridge, wherein the reaction chamber contains a catalyst that promotes a hydrogen production reaction.

12. The hydrogen generation system of claim 11, wherein the reaction chamber is located within the hydrogen separation chamber of the fuel cartridge.

13. The hydrogen generation system of claim 11, wherein the reaction chamber is located external to the hydrogen separation chamber of the fuel cartridge.

14. The hydrogen generation system of claim 11, wherein the catalyst comprises a metal from Group 1B to Group VIIIB of the Periodic Table, either utilized individually or in a mixture, or as compounds of these metals.

15. The hydrogen generation system of claim 1, wherein the hydrogen separation chamber comprises a hydrogen separation membrane.

16. The hydrogen generation system of claim 1, wherein the fuel regulator is in fluid communication with each of the fuel storage chamber and the reaction chamber.

17. The hydrogen generation system of claim 16, wherein the fuel regulator is selected from the group consisting of a piston pump, a peristaltic pump, and a diaphragm pump.

18. The hydrogen generation system of claim 1, wherein the fuel storage chamber comprises a mixing element, and the balance of plant module comprises a fuel mixer driver for controlling the mixing element.

19. The hydrogen generation system of claim 18, wherein the mixing element is selected from the group consisting of a tumbler, propeller, magnetic stirrer, blender, vibration mixer, sonicator, circulation pump or air nozzle.

20. The hydrogen generation system of claim 18, wherein the mixing element comprises a magnetic stir bar located within the fuel chamber and a rotating magnet within the fuel mixer driver.

21. The hydrogen generation system of claim 18, wherein the fuel storage chamber further comprises a perforated screen.

22. The hydrogen generation system of claim 21, wherein the perforated screen is capable of preventing the individual fuel packets from interfering with the mixing element located within the fuel cartridge on an opposite side of the perforated screen from the fuel packets.

23. The hydrogen generation system of claim 1, further comprising a water management module in fluid communication with the balance of plant module.

24. The hydrogen generation system of claim 23, wherein the water management module further comprises a water reservoir and a water filtration system.

25. The hydrogen generation system of claim 1, further comprising control electronics for controlling the hydrogen generation system.

26. The hydrogen generation system of claim 25, wherein the balance of plant module is in electrical communication with the fuel cartridge.

27. The hydrogen generation system of claim 25, wherein the control electronics are located within the balance of plant module.

28. A fuel cartridge comprising:
a hydrogen separation chamber; and
a fuel storage chamber, including at least one individual fuel packet containing a solid fuel.

29. The fuel cartridge of claim 28, wherein the hydrogen separation chamber and the fuel storage chamber are separated by a moveable partition such that the hydrogen separation chamber and the fuel storage chamber are configured in a volume-exchange configuration.

30. The fuel cartridge of claim 28, wherein the fuel storage chamber comprises a plurality of individual fuel packets.

31. The fuel cartridge of claim 28, further comprising a reaction chamber in communication with the hydrogen separation chamber, wherein the reaction chamber contains a catalyst that promotes a hydrogen production reaction.

32. The fuel cartridge of claim 31, wherein the catalyst is a metal from Group 1B to Group VIIIB of the Periodic Table, either utilized individually or in a mixture, or as compounds of these metals.

33. The fuel cartridge of claim 28, wherein the hydrogen separation chamber comprises a hydrogen separation membrane.

34. The fuel cartridge of claim 28, further comprising a fuel regulator in fluid communication with each of the fuel storage chamber and the reaction chamber.

35. The fuel cartridge of claim 34, wherein the fuel regulator comprises a pump.

36. The fuel cartridge of claim 28, wherein the fuel storage chamber comprises a mixing element.

37. The fuel cartridge of claim 36, wherein the mixing element is selected from the group consisting of a tumbler, propeller, magnetic stirrer, blender, vibration mixer, sonicator, circulation pump or air nozzle.

38. The fuel cartridge of claim 36, wherein the fuel storage chamber further comprises a perforated screen.

39. The fuel cartridge of claim 38, wherein the perforated screen is capable of preventing the individual fuel packets from interfering with the mixing element located within the fuel cartridge on an opposite side of the perforated screen from the fuel packets.

40. A fuel packet for use in a hydrogen generation system, wherein the fuel packet is configured to hold a solid fuel and is capable of expanding to a capacity sufficient to hold a predetermined amount of liquid.

41. The fuel packet of claim 40, wherein the fuel packet is further configured to rupture.

42. The fuel packet of claim 40, wherein the fuel packet is composed of a flexible liquid-tight material.

43. The fuel packet of claim 42, wherein the flexible liquid-tight material is selected from the group consisting of nylon; polyurethane; polyvinylchloride (PVC); low density polyethylene (LDPE), linear low density polyethylene (LLDPE), high density polyethylene (HDPE), ethylene-vinyl acetate copolymers (EVA); natural rubber; synthetic rubber; and metal foil.

44. The fuel packet of claim 40, wherein the fuel packet is composed of a dissolvable material.

45. The fuel packet of claim 44, wherein the dissolvable material is selected from the group consisting of cellulose, starch, polyvinyl alcohol (PVA) and polyurethane.

46. A power system comprising:
a fuel cartridge module;
a balance of plant module in fluid communication with the fuel cartridge module;
a water management module in fluid communication with the balance of plant module;
a control module in electrical communication with the balance of plant module; and
a fuel cell power module in fluid communication with the balance of plant module.

47. The power system of claim 46, wherein the fuel cartridge module further comprises:
a hydrogen separation chamber;
a fuel storage chamber, including at least one individual fuel packet containing a solid fuel; and
a movable partition separating the hydrogen separation chamber and the fuel storage chamber, such that the hydrogen separation chamber and the fuel storage chamber are configured in a volume-exchange configuration.

48. The power system of claim 47, wherein the fuel cartridge module comprises a plurality of individual fuel packets.

49. The power system of claim 46, wherein the water management module further comprises a water reservoir and a water filtration system.

50. The power system of claim 46, further comprising a plurality of fuel cartridges and a plurality of balance of plant modules.

51. A method of hydrogen generation comprising:
storing solid fuel in individual pre-measured units;
delivering liquid to the individual pre-measured units, wherein the liquid is directed to a single individual pre-measured unit at a time;
rupturing a pre-measured unit;
forming a fuel solution by mixing the solid fuel with the liquid;
reacting the fuel solution to form hydrogen gas and a byproduct; and
separating the hydrogen gas from the byproduct.

52. The method of claim 51, further comprising feeding the hydrogen gas to a power module.

53. The method of claim 52, wherein the power module comprises a fuel cell.

54. The method of claim 51, wherein reacting the fuel solution to form hydrogen is regulated in accordance with hydrogen demands of a fuel cell.

55. The method of claim 51, wherein the solid fuel is a boron hydride.

56. The method of claim 51, wherein the solid fuel is selected from the group consisting of neutral borane compounds such as decaborane(14) (B₁₀H₁₄);
ammonia borane compounds of formula NHₓBH_{y} and NHₓRBH_{y}, wherein x and y independently equal from 1 to 4 and do not have to be the same, and R is a methyl or ethyl group; borazane (NH₃BH₃); borohydride salts (M(BH₄)ₙ), triborohydride salts (M(B₃H₈)ₙ), decahydrodecaborate salts (M₂(B₁₀H₁₀)ₙ), tridecahydrodecaborate salts (M(B₁₀H₁₃)ₙ), dodecahydrododecaborate salts (M₂(B₁₂H₁₂)ₙ), and octadecahydroicosaborate salts (M₂(B₂₀H₁₈)ₙ), wherein M is a cation selected from the group consisting of alkali metal cations, alkaline earth metal cations, aluminum cation, zinc cation, and ammonium cation, and wherein n is equal to the charge of the cation.

57. The method of claim 56, wherein the solid fuel further comprises a stabilizer component.

58. The method of claim 51, wherein the solid fuel is stored in a dry form.

59. The method of claim 58, wherein the solid fuel is stored in the form of granules, pellets and powder.

60. The method of claim 51, wherein the individual pre-measured units rupture by the buildup of fluid pressure within the individual pre-measured unit.

61. The method of claim 51, wherein the individual pre-measured units rupture in response to an external mechanical force.

62. The method of claim 51, wherein the step of reacting the fuel solution further comprises:
conveying the fuel solution to a reaction chamber;
reacting the fuel solution within the reaction chamber; and
conveying the hydrogen gas and the byproduct to a hydrogen separation chamber.
